(19) United States
(12) Patent Application Publication
(10) Pub. No.: US 2026/0071772 A1
(43) Pub. Date: Mar. 12, 2026

(54) SYSTEM AND METHOD INTEGRATING ENERGY MANAGEMENT AND INVERTER HEAT PUMP

(71) Applicant: Daikin Comfort Technologies Manufacturing, L.P., Waller, TX (US)

(72) Inventors: Dennis Thoren, Camarillo, CA (US); Steve Dushane, Granada Hills, CA (US); Mustafa Oransel, Agoura Hills, CA (US); Gang Chen, Katy, TX (US)

(73) Assignee: Daikin Comfort Technologies Manufacturing, L.P., Waller, TX (US)

(21) Appl. No.: 18/828,907

(22) Filed: Sep. 9, 2024

(51) Int. Cl. F24F 11/47; F24F 11/37; F24F 11/64; F24F 11/83; F24F 11/86; F24F 110/10; F24F 110/20; F24F 140/60

(52) U.S. Cl. CPC F24F 11/47; F24F 11/37; F24F 11/64; F24F 11/83; F24F 11/86; F24F 2110/10; F24F 2110/20; F24F 2140/60

(57) ABSTRACT

A heating, ventilation, and air conditioning system for adjusting the indoor temperature of a structure connected to an electric utility grid includes: an energy storage system; an inverter heat pump including a variable speed compressor controlled by an inverter to operate over a range of 0% to 100% of a maximum compressor speed, the inverter heat pump being electrically connected to the energy storage system and the electric utility grid; and a home energy management system (HEMS) including a controller operatively connected to the inverter heat pump, the controller being programmed to receive inputs comprising at least one of an indoor temperature measurement, a user-determined temperature setpoint, an indoor humidity measurement, or a user-determined humidity setpoint and set a compressor speed of the inverter heat pump in response to the inputs, the HEMS controlling whether the variable speed compressor is powered by electric utility grid or the energy storage system.

### BACKGROUND

This section is intended to introduce the reader to various aspects of the art that may be related to various aspects of the presently described embodiments-to help facilitate a better understanding of various aspects of the present embodiments. Accordingly, it should be understood that these statements are to be read in this light, and not as admissions of prior art.

Home or business energy consumption is strongly affected by indoor heating and cooling requirements. Energy costs are affected by energy consumption as well as energy rates such as the rates charged by an electric utility company. These rates may also vary according to dynamic time of use rates published by the electric utility company.

For at least economic reasons, minimizing energy consumption and energy costs while maintaining comfort conditioning (understood as user-desired temperature and humidity) of the indoor environment is desirable. Additionally, for environmental reasons, minimizing energy consumption and decarbonization may also be desirable.

Managing home energy consumption involves monitoring and controlling energy usage as a function of time considering other factors including one or more of time-dependent electric utility rates, temperature and humidity setpoints for one or more zones of the home, differential between setpoints and measured values for temperature and humidity, amount of stored electrical energy stored in an electrical energy storage system. This system may include one or more batteries or any number of other forms of energy storage.

A home energy management system (HEMS) may include smart meters, an Internet of Things (IoT), charging for electric vehicles (EV), fuel cells, a geothermal heating and cooling system among other devices.

A residential energy consumer may benefit from a HEMS that includes an inverter heat pump for a number of reasons.

One of the biggest demands on energy in a home is the Heating, Ventilation, and Air Conditioning (HVAC) system. As such, managing home energy consumption reasonably incorporates managing the HVAC system.

Refrigerant systems are utilized to control the temperature and humidity of air in various indoor environments to be conditioned.

A heat pump is a refrigerant system that is typically operable in both cooling and heating modes. While air conditioners are familiar examples of heat pumps, the term “heat pump” is more general and applies to many heating, ventilating, and air conditioning (HVAC) devices used for space heating or space cooling. When a heat pump is used for heating, it employs the same basic refrigeration-type cycle used by an air conditioner or a refrigerator, but in the opposite direction, releasing heat into the conditioned space rather than the surrounding environment. In this use, heat pumps generally draw heat from cooler external air, water, or from the ground.

In a cooling mode, a heat pump operates like a typical air conditioner, i.e., a refrigerant is compressed in a compressor and delivered to a condenser (or an outdoor heat exchanger). In the condenser, heat is exchanged between a medium such as outside air, water, or the like and the refrigerant. From the condenser, the refrigerant passes to an expansion device, at which the refrigerant is expanded to a lower pressure and temperature, and then to an evaporator (or an indoor heat exchanger). In the evaporator, heat is exchanged between the refrigerant and the indoor air, to condition the indoor air. When the refrigerant system is operating, the evaporator cools the air that is being supplied to the indoor environment. In addition, as the temperature of the indoor air is lowered, moisture usually is also taken out of the air. In this manner, the humidity level of the indoor air can also be controlled.

Reversible heat pumps work in either direction to provide heating or cooling to the internal space as mentioned above. Reversible heat pumps employ a reversing valve to reverse the flow of refrigerant from the compressor through the condenser and evaporation coils. In heating mode, the outdoor coil is an evaporator, while the indoor coil is a condenser. The refrigerant flowing from the evaporator (outdoor coil) carries the thermal energy from outside air (or source such as water, soil, etc.) indoors. Vapor temperature is augmented within the pump by compressing it. The indoor coil then transfers thermal energy (including energy from the compression) to the indoor air, which is then moved around the inside of the building by an air handler. The refrigerant is then allowed to expand, cool, and absorb heat from the outdoor temperature in the outside evaporator, and the cycle repeats. This is a standard refrigeration cycle, save that the “cold” side of the refrigerator (the evaporator coil) is positioned so it is outdoors where the environment is colder.

A battery is a device capable of storing energy that may be released in the form of electrical energy. A rechargeable battery may also repeatedly store and release energy. Unless otherwise explicitly noted, batteries as disclosed herein are rechargeable.

While a battery may store energy in chemical form, in this disclosure, a battery refers more generally to any form of energy storage that may be released as electrical energy unless otherwise explicitly noted. Examples of other forms of energy storage include mechanical energy storage such as flywheels, displacement of a mass in a gravitational field (for example, raising a solid mass or a volume of a liquid) shape distortion (for example, torsion, spring compression, or spring extension), thermal energy storage (for example, a heated mass that heats fluid that flows through the mass, the heated fluid used to power an electric generator), and electrical energy storage (for example, supercapacitors).

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to a home (or business) energy management system. In another embodiment, a method of managing energy in a structure is disclosed. Advantageously, certain disclosed embodiments may provide reduced energy consumption and/or lower cost energy while maintaining comfort conditioning of the user(s)/occupant(s) of the home or business.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings.

FIG. 1 is a block diagram of a HEMS in accordance with one or more embodiments of the present disclosure.

FIG. 2 is flowchart of a method for managing home energy in accordance with one or more embodiments of the present disclosure.

FIG. 3 is a block diagram of a controller in accordance with one or more embodiments of the present disclosure.

### DETAILED DESCRIPTION

One or more specific embodiments of the present disclosure will be described below. In an effort to provide a concise description of these embodiments, not all features of an actual implementation may be described. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

The present disclosure relates to hems and method of controlling the same.

The present disclosure supports decarbonization with the systems and methods presented herein. A HEMS may include a solar energy source, for example an array of photovoltaic panels, though other forms of solar energy collection may be included, particularly when the collected energy can be converted into electrical energy.

An inverter HVAC system or inverter heat pump has a lower inrush current than traditional single stage or dual stage HVAC systems. Inrush current results from the demand from the HVAC system as it turns on the compressor. Traditional HVAC systems are binary in operation, either operating at maximum or off. Thus, switching from off to maximum demands a large inrush current. In contrast, inverter-equipped systems operate variably from 0% and 100%, say, perhaps around 30% of maximum, and can ramp up gradually from 0% to a desired operating percentage. Inverter-equipped systems typically remain on at some level, thus avoiding inrush currents due to starting up. Further, when inverter-equipped systems do start up, they turn on at a lower level, thus reducing the inrush current. The lower inrush current of the inverter-equipped systems can reduce the amount of battery storage required.

An inverter HVAC or inverter heat pump, by using an inverter-driven variable speed compressor, can take advantage of a lower inrush current than traditional systems and use a smaller battery system whose ability to supply the inrush current to an inverter system would be sufficient, but would be insufficient to supply inrush current to a traditional system. With a smaller battery system, the solar energy source could also be scaled down. The smaller battery system and smaller solar energy source may reduce initial installation and start-up costs when compared to installing a traditional system.

In addition, the HEMS and method disclosed herein optimizes the HVAC or inverter system energy demand to maximize human comfort during electric utility grid outages while also maximizing battery charge life.

The HEMS and method of the present disclosure also optimizes the system operation with dynamic time of use electric utility rates to minimize cost for the home or building owner, drawing on the battery for electric energy to operate the compressor during high rate periods.

A control method for controlling the energy consumption of an inverter heat pump is presented below. With an inverter heat pump, the HVAC system using the inverter heat pump does not need to operate in a binary on/off fashion (that is, 100% or 0%). Instead, the inverter heat pump can operate in a steadier manner at an intermediate speed, say, 30%, with the compressor speed varying to meet the demand for cooling or heating. Operating at varying speeds instead of only at maximum speed or off, the inverter heat pump can run more efficiently and consume less energy. Thus, when the electric utility grid is unavailable to a structure due to weather-related grid outages, such as during periods of extreme heat or cold, the battery energy storage system can extend the time providing comfort conditioning to the user/occupant by supplying electrical energy to operate the compressor.

In at least one embodiment, the control method employs a reduction in the inverter drive compressor speed and therefore a reduction in energy demand. Energy demand can be calculated or/predicted based on either the prior seasonal artificial intelligence (AI) and/or machine learning-based average time period the grid has been off or scheduled outage times communicated by the grid supply operator or utility. This control method provides as much human comfort conditioning for the home or business as possible by supplying a time-based energy budget for the inverter heat pump in a home or business. The result is to maintain best effort comfort in the conditioned space with the goal of attempting to maintain user selected temperature and/or humidity setpoints while conserving the capacity of the energy storage system or other available energy sources.

In one or more embodiments, the control method includes using prior seasonal data to predict at least one of an outage of the electric utility grid, the probability of an outage of the electric utility grid, or the duration of an outage of the electric utility grid and to appropriately prioritize storing energy in the energy storage system in anticipation of such an outage.

As a further enhancement of the disclosed control method, a zoning system control strategy may be employed where zones for different spaces within the structure, such as a primary bedroom and/or children's bedrooms, are automatically prioritized to provide comfort conditioning during time periods where the electrical grid supplied electricity is unavailable. This serves to further maximize human comfort and safety during grid outage events by extending the run time of the inverter heat pump using battery energy storage.

Prioritization may also be set by occupancy sensors. Sensors such as motion sensors or infrared (IR) sensors can detect occupancy of a zone, and occupied zones can be prioritized for maintenance of comfort conditioning.

Another enhancement that can be overlayed or independently deployed considers electric rates that vary with time. With this method, Dynamic Time of Use (TOU) electric utility cloud API published rates are used as a control input variable to a cost algorithm that determines the minimum energy cost at a given time. The cost algorithm may include operational energy supply costs from solar, battery storage, and electric utility sourced energy dynamic pricing inputs. The control method solves to achieve lowest operating costs by selecting the lowest cost supply inputs to a HEMS system while minimizing the largest electrical energy demand which is the HVAC systems in homes.

Further integration of alternate inverter driven energy storage systems may use water (hot or cold) to provide an additional energy storage source to integrate into the above systems based approaches to overall HEMS energy management algorithms.

In one or more embodiments, an HVAC system for adjusting the indoor temperature of a structure connected to an electric utility grid includes: an energy storage system configured to store electrical energy; an inverter heat pump comprising a variable speed compressor controlled by an inverter to operate over an inclusive range of 0% to 100% of a maximum compressor speed for the compressor, the inverter heat pump being electrically connected to the energy storage system and the electric utility grid; and a home energy management system (HEMS) comprising a controller operatively connected to the inverter heat pump, the controller being programmed to receive inputs comprising at least one of an indoor temperature measurement, a user-determined temperature setpoint, an indoor humidity measurement, or a user-determined humidity setpoint and set a compressor speed of the inverter heat pump in response to the inputs, the HEMS controlling whether the variable speed compressor is powered by electric utility grid or the energy storage system. In one or more embodiments, the inputs may include an indoor humidity measurement and a user-determined humidity setpoint. These humidity-related inputs may be used in addition to or instead of the temperature-related inputs.

In another embodiment, the HVAC described above may further include a solar energy source electrically connected to the energy storage system, where another of the inputs is a measurement of generated solar energy.

In yet another embodiment, the structure comprises a plurality of zones, each zone comprising at least one sensor including a temperature sensor and/or a humidity sensor that acquires data used as input to the controller and a damper operable to control an airflow from the inverter heat pump into the zone, and the inputs further comprise the user-determined temperature setpoint for each zone, the user-determined humidity setpoint for each zone, and user-provided zone prioritization with regard to achieving the user-determined setpoints for the zones. In one or more embodiments, the inputs may include in each zone an indoor humidity measurement and a user-determined humidity setpoint. These humidity-related inputs may be used in addition to or instead of the temperature-related inputs.

In yet another embodiment, the controller automatically prioritizes bedroom zones.

In another embodiment, where the inputs include at least the user-determined temperature setpoint and the user-determined humidity setpoint, the controller is programmed to control the compressor to reduce an energy demand of the HVAC system during an electric grid outage to conserve a capacity of the energy storage system to power the inverter heat pump while maintaining the indoor temperature as close to the user-determined temperature setpoint and/or the indoor humidity as close to the user-determined humidity setpoint as possible.

In another embodiment, the inputs further include dynamic time of use electric utility grid rates, and the controller is programmed to minimize a cost using a cost algorithm used to analyze operational energy supply costs from the solar energy source, the energy storage system, and the electric utility grid dynamic time of use and select the lowest cost energy supply.

In another embodiment, the inputs further include at least one of: sensor measurements including at least one of an indoor temperature, an indoor humidity, an electric current drawn by the compressor, a voltage across the compressor, an HVAC refrigerant pressure, an HVAC refrigerant temperature, a compressor speed, or an energy storage system “fill percentage,” data including at least one of weather data, climate data, or electric utility grid outage data, or reference data including at least one of equipment ratings, charge curves for the energy storage system, or discharge curves for the energy storage system.

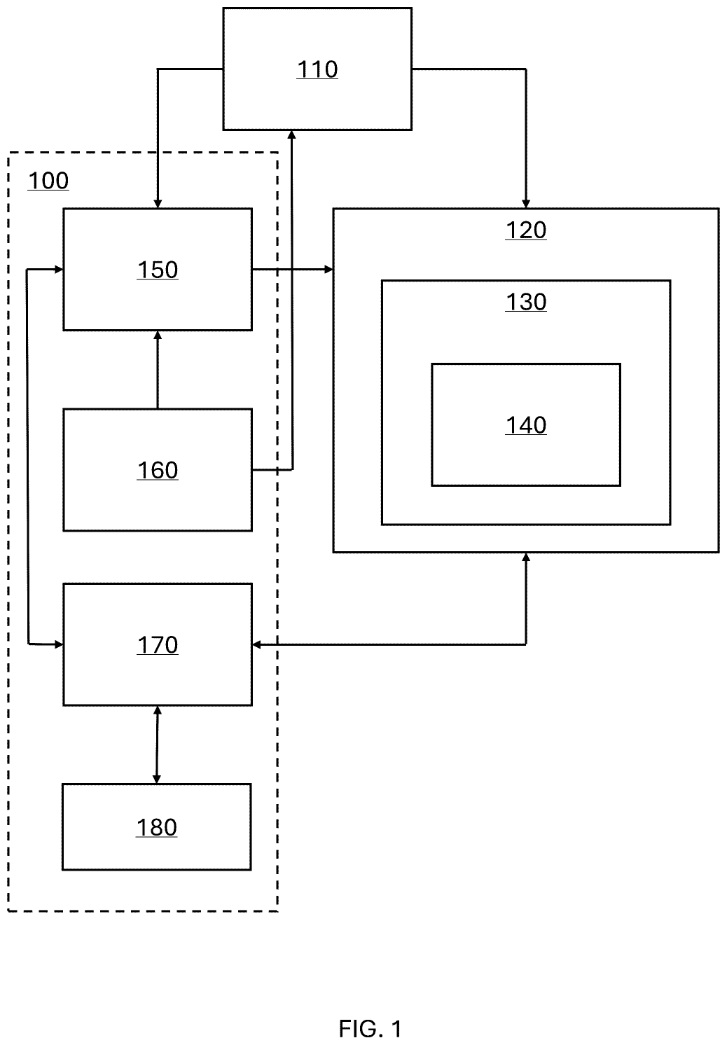

Turning now to the figures, FIG. 1 is a block diagram of a HEMS 100, shown in the dashed box. The HEMS 100 may be electrically connected to an electric utility grid 110. For illustration purposes, FIG. 1 shows the electric utility grid 110 providing electricity through two entry points. However, there may be one or more than two entry points.

The HEMS 100 may optionally include an HVAC system 120 (FIG. 1 shows the HVAC system as separate from the HEMS.) The HEMS 100 may also include other items not shown that utilize electrical energy. For example, refrigerators, ovens, microwaves, lighting, computers, televisions, and the like may be included. The HVAC system 120 may include an inverter heat pump 130. The inverter heat pump 130 uses an inverter drive to control a variable speed compressor 140. The variable speed compressor 140 can operate at any speed between 0% (off) and 100% of the rated speed of the compressor 140. For example, it may operate between 30% and 60% of its rated speed. This submaximal operation allows the compressor 140 to operate at greater efficiency than traditional HVAC systems that are only operating at either off or a maximum speed. The compressor 140 also requires lower inrush current when the compressor 140 starts up because it does not need to turn on at 100% of its rated speed.

The HEMS 100 may also include an energy storage system 150. The energy storage system 150 may be one or more batteries. As described above, other forms of storing energy are also possible, and unless otherwise noted, a battery is understood herein to include those other forms.

The HEMS 100 may also include a solar energy source 160. The solar energy source 160 may be an array of photovoltaic (PV) cells, though other forms of solar energy collection may also serve as the solar energy source 160 provided the collected energy is converted to electrical energy. Other renewable energy sources, for example, wind turbines or windmills, may also be included in the HEMS 100 in a manner similar to that of the solar energy source 160.

The electric utility grid 110 supplies electrical energy to the structure, including to the HVAC system 120 and the energy storage system 150. The solar energy source 160 may also provide electrical energy to the structure, for storage in the energy storage system 150, or to the electric utility grid 110. The electrical energy passing from the solar energy source 160 to the electric utility grid 110 may do so by direct connection or indirectly by passing through the energy storage system 150.

The HEMS 100 also includes a controller 170. The controller 170 may be operatively connected the energy storage system 150 and the HVAC system 120. The controller 170 may receive data from sensors and other sources both inside and outside the HEMS 100. The controller 170 is also operatively connected to a user interface 180. The controller 170 may receive user input via the user interface 180 regarding temperature and/or humidity setpoints in one or more zones in the home or business as well as prioritization of zones for maintaining comfort conditioning for occupants. Prioritization of extending energy storage system life during power outages vs. maintaining comfort conditioning may also be selected by the user via the user interface 180. For example, a user may be presented with a simple choice of maximum comfort or maximum duration. Of course, other options in between and even custom settings are available. The controller 170 may connect to and be in communication with other devices inside and outside the home using wired or wireless connections. For example, the user interface 180 may be a hard-mounted device within the home or it may be an application (app) running on a mobile device, laptop computer, desktop computer, tablet, or similar device.

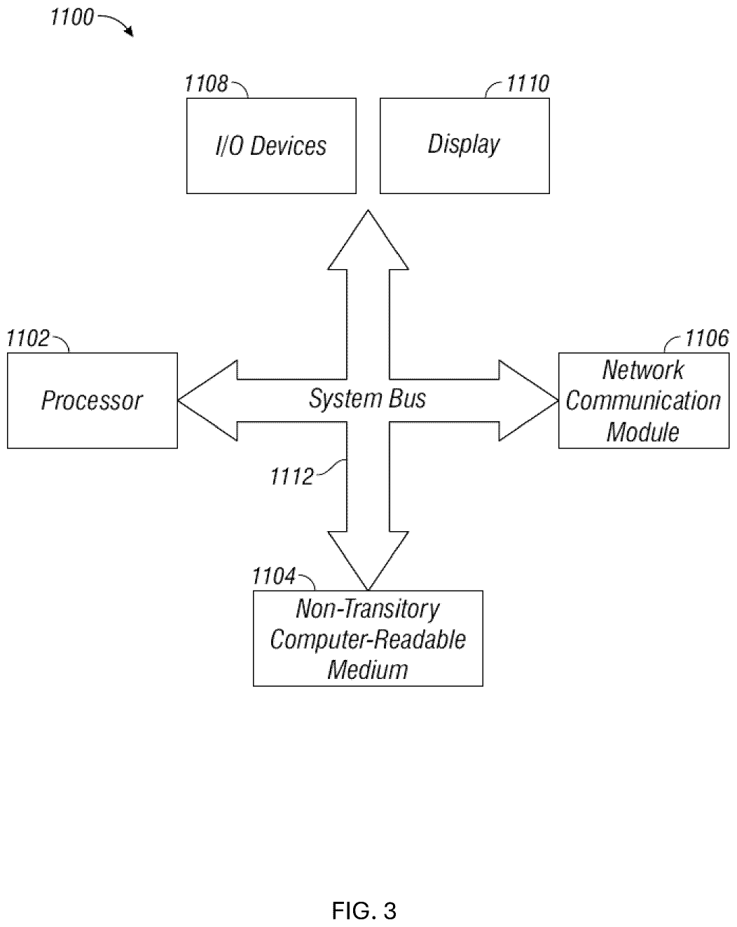

Referring to FIG. 3, the controller includes at least one processor 1102, a non-transitory computer readable medium 1104, an optional network communication module 1106, optional input/output devices 1108, a data storage drive or device, and an optional display 1110 all interconnected via a system bus 1112. In at least one embodiment, the input/output device 1108 and the display 1110 may be combined into a single device, such as a touch-screen display. Software instructions executable by the processor 1102 for implementing software instructions stored within the controller 1100 in accordance with the illustrative embodiments described herein, may be stored in the non-transitory computer readable medium 1104 or some other non-transitory computer-readable medium.

The controller 1100 may be realized by, for example, a computer. The computer that constitutes the controller 1100 may include a control calculation device and a storage device. For the control calculation device, a processor such as a CPU or a GPU may be used. The control calculation device reads a program that is stored in the data storage device and performs a predetermined computing processing operation in accordance with the program. Further, the control calculation device writes a calculated result to the storage device and reads information stored in the storage device in accordance with the program. Alternatively, the controller 1100 may be formed by using an integrated circuit (IC) that can perform control similar to the control that is performed by using a CPU. Here, IC includes, for example, LSI (large-scale integrated circuit), ASIC (application-specific integrated circuit), a gate array, and FPGA (field programmable gate array).

Although not explicitly shown in FIG. 3, it will be recognized that the controller 1100 may be connected to one or more public and/or private networks via appropriate network connections. It will also be recognized that software instructions may also be loaded into the non-transitory computer readable medium 1104 from an appropriate storage media or via wired or wireless means.

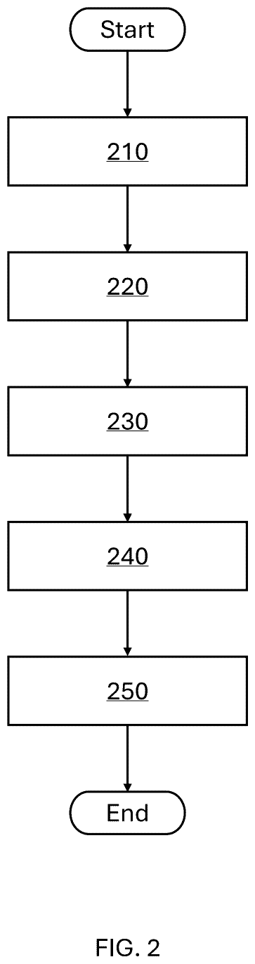

Referring now to FIG. 2, one or more embodiments of the present disclosure are methods of controlling energy consumption of an HVAC system in adjusting the indoor temperature of a structure connected to an electric utility grid. The methods include measuring, using a sensor, an indoor temperature and/or an indoor humidity of the structure 210 and acquiring a user-determined temperature setpoint and/or user-determined humidity setpoint using a HEMS that includes a controller 220. The methods further include determining an amount of electrical energy stored in an energy storage system storing electrical energy 230; controlling a variable-speed compressor in an inverter heat pump with the HEMS to adjust a compressor speed for the compressor based on at least one of the measured indoor temperature and the temperature setpoint or the measured indoor humidity and the humidity setpoint 240; and controlling with the HEMS whether the variable speed compressor is powered by the electric utility grid or the energy storage system 250.

In one or more embodiments, the method may also include measuring, with a first sensor, the amount of electrical energy stored in the energy storage system; acquiring, with the HEMS, an average energy output from a solar energy source electrically connected to the energy storage system; acquiring, using the HEMS, prior seasonal average time period of grid outage data; determining, using the controller, a compressor speed based on the grid outage data and the at least one temperature setpoint and/or at least one humidity setpoint that conserves use of energy from the energy storage system to power the compressor; and controlling the compressor with the controller to operate at the determined compressor speed.

In one or more embodiments, the method also includes measuring an indoor temperature in each of a plurality of zones and/or an indoor humidity in each of a plurality of zones; setting a temperature setpoint for each of the plurality of zones and/or humidity setpoint for each of the plurality of zones; determining, using the controller, a compressor speed additionally constrained by the measurements of each temperature and/or humidity sensor and the temperature and/or humidity setpoint, respectively, for each of the plurality of zones; and setting the compressor speed to the determined compressor speed.

In one or more embodiments, the method further includes measuring, using a temperature sensor and/or a humidity sensor, a temperature and/or a humidity, respectively, in each of a plurality of zones; setting a temperature setpoint and/or a humidity setpoint, respectively, for each of the plurality of zones; determining, using the controller, a compressor speed additionally constrained by the measurements of each temperature sensor and the temperature setpoint and/or each humidity sensor and humidity setpoint for each of the plurality of zones; and setting the compressor speed to the determined compressor speed.

In one or more embodiments, the method also includes acquiring, using the HEMS, dynamic time of use (DTOU) published rate data; determining, with the controller, a minimum cost using the DTOU published rate data and the operational energy supply costs from the solar energy source, the energy storage system, and the electric utility grid; and switching to the lowest energy supply cost.

In one or more embodiments, the energy storage system includes comprising storing thermal energy in the energy storage system with water serving as a thermal energy reservoir to supplement or replace another mode of energy storage. The water may be stored in a container and may be available (for example, by a valve) to be in thermal communication with refrigerant in the HVAC system.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims. For example, certain embodiments disclosed here envisage usage with a powered fan rather than an inducer fan, or no fan at all. Moreover, the rotating equipment (e.g., motors) and valves disclosed herein are envisaged as being operable at specified speeds or variable speeds through inverter circuitry, for example. Moreover, the internal and external communication of the HEMS may be accomplished through wired and or wireless communications, including known communication protocols, Wi-Fi, 802.11(x), Bluetooth, to name just a few.

What is claimed is:

1. A heating, ventilation, and air conditioning (HVAC) system for adjusting the indoor temperature of a structure connected to an electric utility grid, comprising:
an energy storage system configured to store electrical energy;
an inverter heat pump comprising a variable speed compressor controlled by an inverter to operate over an inclusive range of 0% to 100% of a maximum compressor speed for the compressor, the inverter heat pump being electrically connected to the energy storage system and the electric utility grid; and
a home energy management system (HEMS) comprising a controller operatively connected to the inverter heat pump, the controller being programmed to receive inputs comprising at least one of an indoor temperature measurement, a user-determined temperature setpoint, an indoor humidity measurement, or a user-determined humidity setpoint and set a compressor speed of the inverter heat pump in response to the inputs, the HEMS controlling whether the variable speed compressor is powered by electric utility grid or the energy storage system.

2. The HVAC system of claim 1 further comprising a solar energy source electrically connected to the energy storage system, wherein the inputs further comprise a measurement of generated solar energy.

3. The HVAC system of claim 1, wherein:
the structure comprises a plurality of zones, each zone comprising at least one sensor including a temperature sensor and/or a humidity sensor that acquires data used as input to the controller and a damper operable to control an airflow from the inverter heat pump into the zone, and
the inputs further comprise the user-determined temperature setpoint for each zone, the user-determined humidity setpoint for each zone, and a user-provided zone prioritization with regard to achieving the user-determined setpoints for the zones.

4. The HVAC system of claim 3, wherein the controller automatically prioritizes bedroom zones.

5. The HVAC system of claim 1, wherein the inputs comprise at least the user-determined temperature setpoint and the user-determined humidity setpoint, wherein the controller is programmed to control the compressor to reduce an energy demand of the HVAC system during an electric grid outage to conserve a capacity of the energy storage system to power the inverter heat pump while maintaining the indoor temperature as close to the user-determined temperature setpoint and/or the indoor humidity as close to the user-determined humidity setpoint as possible.

6. The HVAC system of claim 2, wherein:
the inputs further comprise dynamic time of use electric utility grid rates, and
the controller is programmed to minimize a cost using a cost algorithm used to analyze operational energy supply costs from the solar energy source, the energy storage system, and the electric utility grid dynamic time of use and select the lowest cost energy supply.

7. The HVAC system of claim 2, wherein the inputs further comprise at least one of:
measurements comprising at least one of an electric current drawn by the compressor, a voltage across the compressor, an HVAC refrigerant pressure, an HVAC refrigerant temperature, a compressor speed, or an energy storage system “fill percentage,”
data comprising at least one of weather data, climate data, or electric utility grid outage data, or
reference data comprising at least one of equipment ratings, charge curves for the energy storage system, or discharge curves for the energy storage system.

8. The HVAC system of claim 2, wherein the energy storage system comprises a container to store water in thermal communication with refrigerant in the HVAC system.

9. A method of controlling energy consumption of a heating, ventilation, and air conditioning (HVAC) system in adjusting the indoor temperature of a structure connected to an electric utility grid, the method comprising:
measuring, using a sensor, an indoor temperature and/or an indoor humidity of the structure;
acquiring a user-determined temperature setpoint and/or a user-determined humidity setpoint using a home energy management system (HEMS) that includes a controller;
determining an amount of electrical energy stored in an energy storage system storing electrical energy;
controlling a variable-speed compressor in an inverter heat pump with the HEMS to adjust a compressor speed for the compressor based on at least one of the measured indoor temperature and the temperature setpoint or the measured indoor humidity and the humidity setpoint; and
controlling with the HEMS whether the variable speed compressor is powered by the electric utility grid or the energy storage system.

10. The method of claim 9, further comprising:
measuring, with a first sensor, the amount of electrical energy stored in the energy storage system;
acquiring, with the HEMS, an average energy output from a solar energy source electrically connected to the energy storage system;
acquiring, using the HEMS, prior seasonal average time period of grid outage data;
determining, using the controller, a compressor speed based on the grid outage data and the at least one temperature setpoint and/or the at least one humidity setpoint that conserves use of energy from the energy storage system to power the compressor; and
controlling the compressor with the controller to operate at the determined compressor speed.

11. The method of claim 9, further comprising:
measuring a temperature and/or a humidity in each of a plurality of zones;
setting a temperature setpoint and/or humidity setpoint for each of the plurality of zones;
determining, using the controller, a compressor speed additionally constrained by the measurements of each temperature sensor and/or humidity sensor and the temperature setpoint and/or humidity setpoint, respectively, for each of the plurality of zones; and
setting the compressor speed to the determined compressor speed.

12. The method of claim 10, further comprising:
measuring, using a temperature sensor, a temperature in each of a plurality of zones and/or measuring, using a humidity sensor, a humidity in each of the plurality of zones;
setting a temperature setpoint and/or a humidity setpoint, respectively, for each of the plurality of zones;
determining, using the controller, a compressor speed additionally constrained by the measurements of each temperature sensor and/or each humidity sensor and the temperature setpoint and/or humidity setpoint, respectively, for each of the plurality of zones; and
setting the compressor speed to the determined compressor speed.

13. The method of claim 10, further comprising:
acquiring, using the HEMS, dynamic time of use (DTOU) published rate data;
determining, with the controller, a minimum cost using the DTOU published rate data and the operational energy supply costs from the solar energy source, the energy storage system, and the electric utility grid; and
switching to the lowest energy supply cost.

14. The method of claim 9, further comprising storing thermal energy in the energy storage system with water serving as a thermal energy reservoir to supplement or replace another mode of energy storage.

15. The method of claim 10, further comprising storing thermal energy in the energy storage system with water serving as a thermal energy reservoir to supplement or replace another mode of energy storage.

16. A heating, ventilation, and air conditioning (HVAC) system for adjusting the indoor temperature of a structure connected to an electric utility grid, the HVAC system comprising a plurality of zones, comprising:
an energy storage system configured to store electrical energy;
an inverter heat pump comprising a variable speed compressor controlled by an inverter to operate over an inclusive range of 0% to 100% of a maximum compressor speed for the compressor, the inverter heat pump being electrically connected to the energy storage system and the electric utility grid;
temperature sensors and/or humidity sensors operable to measure temperature and/or indoor humidity for each zone; and
a home energy management system (HEMS) comprising a controller operatively connected to the inverter heat pump, the controller being programmed to receive inputs comprising, for each zone, an indoor temperature measurement and a user-determined temperature setpoint and/or an indoor humidity measurement and a user-determined humidity setpoint and set a compressor speed of the inverter heat pump in response to the plurality of inputs, the HEMS controlling whether the variable speed compressor is powered by electric utility grid or the energy storage system ; and
a solar energy source electrically connected to the energy storage system, wherein the plurality of inputs further comprise a measurement of generated solar energy,
wherein the inputs further comprise user-provided zone prioritizations with regard to achieving the user-determined setpoints for the zones.

17. The HVAC system of claim 16, wherein the controller automatically prioritizes bedroom zones.

18. The HVAC system of claim 16, wherein when the controller determines there is an electric grid outage, the controller reduces an energy demand of the HVAC system to conserve a capacity of the energy storage system while providing comfort conditioning during the outage.

19. The HVAC system of claim 16, wherein:
the inputs further comprise dynamic time of use electric utility grid rates, and
the controller minimizes a cost using a cost algorithm to analyze operational energy supply costs from the solar energy source, the energy storage system, and the electric utility grid dynamic time of use and select the lowest cost energy supply.

20. The HVAC system of claim 16, wherein the inputs further comprise at least one of:
measurements comprising at least one of an electric current drawn by the compressor, a voltage across the compressor, an HVAC refrigerant pressure, an HVAC refrigerant temperature, a compressor speed, or an energy storage system “fill percentage,”
historic data comprising at least one of weather data, climate data, or electric utility grid outage data, or
reference data comprising at least one of equipment ratings, or charge and/or discharge curves for the energy storage system.
